(19) United States
(12) Patent Application Publication
(10) Pub. No.: US 2021/0039055 A1
(43) Pub. Date: Feb. 11, 2021

(54) MIXING MANIFOLD AND DELIVERY SYSTEM FOR GAS DELIVERY

(71) Applicant: FLOW DEVICES AND SYSTEMS INC., Yorba Linda, CA (US)

(72) Inventor: Bhushan SOMANI, Yorba Linda, CA (US)

(73) Assignee: FLOW DEVICES AND SYSTEMS INC., Yorba Linda, CA (US)

(21) Appl. No.: 16/981,285

(22) PCT Filed: Mar. 28, 2019
(86) PCT No.: PCT/US2019/024709

§ 371 Date: Sep. 16, 2020

Related U.S. Application Data
(60) Provisional application No. 62/649,306, filed on Mar. 28, 2018.

(51) Int. Cl. B01F 3/02; B01F 15/02; B01F 13/10

(52) U.S. Cl. CPC B01F 3/026; B01F 13/1055; B01F 15/026

(57) ABSTRACT

An electronically or mechanically controlled system is devised, such that the outlet control system in a flow path delivers a desired flow rate of pre-mixed ratio and quantity of gases based on inlet and outlet pressure conditions. The desired flow rate from the system/device does not depend on type of gas/fluid being mixed such that system will always deliver a mixed gas and also do a real-time measurement of actual flow of the mixture.

### CROSS-REFERENCE & PRIORITY CLAIM

This Application claims the benefit of U.S. Provisional Application No. 62/649,306 filed Mar. 28, 2018 entitled “Mixing Manifold and Delivery System to Deliver Critical Process Gas to a Process Module” which is incorporated herein by reference in its entirety.

### BACKGROUND

Most existing technologies deliver gas to a mass flow controller individually and rely on the gas lines downstream from the mass flow controller to flow the desired mixture of gas to a processing chamber. The continues to be a need for further simplification of the mass flow controller system.

### SUMMARY

Various embodiments include a gas delivery system for delivering a mixture of gases, the system includes a plurality of solenoid valves configured to deliver a plurality of different gases to create a mixture of the different gases in a known reference volume, the gas delivery system being configured to determine the partial pressure of each of the different gases in the reference volume, and the gas delivery system being configured to determine a conversion factor based on the partial pressure of each of the different gases to derive a calibration curve specifically for the mixture of the different gases in the reference volume. The gas delivery system being further configured use the calibration curve to flow the desired amount of mixture of the different gases into the chamber.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a gas delivery system for delivering a mixture of gases, the system including: a plurality of solenoid valves configured to deliver a plurality of different gases to create a mixture of the different gases in a known reference volume. The gas delivery system also includes the gas delivery system being configured to determine the partial pressure of each of the different gases in the reference volume. The gas delivery system also includes the gas delivery system being configured to determine a conversion factor based on the partial pressure of each of the different gases to derive a calibration curve specifically for the mixture of the different gases in the reference volume. The gas delivery system also includes the gas delivery system being configured use the calibration curve to flow the desired amount of mixture of the different gases into the chamber. Other embodiments of this aspect include corresponding computer systems, apparatus, and computer programs recorded on one or more computer storage devices, each configured to perform the actions of the methods.

Implementations may include one or more of the following features. The system where the gas mixture includes gases which are non-reactive with each other. The system where said system is configured to characterize the ratio of the gases in a process mixture before delivery into a process module. The system where the system is configured to characterize the volume, density or mass ratio of the gases in the mixture. The system including an outlet valve configured to monitor a flow rate of the process mixture delivered to the process module. The system where the system is configured to control the pressure of a plurality of gas streams such that the partial pressure of the individual gases will equate its desired ratio of the gases in the mixture. The gas delivery system as described where the one or more gases are non-reactive with each other. The gas delivery system as described where the inlet valves is an electronic pressure regulator. The gas delivery system as described further equipped to characterize the ratio of the gases in the process mixture before delivering to the process module. The gas delivery system as described where the inlet valve is chosen from a group including of solenoid, piezoelectric or stepper motor valves. The gas delivery system as described where the outlet valve is configured to monitor a flow rate of the process mixture delivered to the process module. The gas delivery system as described where the control pressure of each stream is such that the partial pressure of the individual gases will equate its desired ratio in the process mixture. The gas delivery system as described further equipped to operate in a continuous mode, where the gas pressure and the control pressure of the orifice is adjusted to maintain a differential pressure across the flow path of the process mixture. The gas delivery system as described further equipped to operate in a on demand real time mixing mode. Implementations of the described techniques may include hardware, a method or process, or computer software on a computer-accessible medium.

One general aspect includes a gas delivery system for delivering a mixture of gases, the system including a plurality of solenoid valves configured to deliver a plurality of different gases to create a mixture of the different gases in a known reference volume. The gas delivery system also includes the gas delivery system being configured to determine a ratio of each of the different gases in the reference volume based on a pressure measured across the plurality of solenoid valves. The gas delivery system also includes the gas delivery system being configured to determine a conversion factor based on the ratio of each of the different gases to derive a calibration curve specifically for the mixture of the different gases in the reference volume. The gas delivery system also includes the gas delivery system being configured to use the calibration curve to flow the desired amount of mixture of the different gases into a processing chamber. Other embodiments of this aspect include corresponding computer systems, apparatus, and computer programs recorded on one or more computer storage devices, each configured to perform the actions of the methods.

Implementations may include one or more of the following features. The system where the gas mixture includes gases which are non-reactive with each other. The system where said system is configured to characterize the ratio of the gases in a process mixture before delivery into a process module. The system where the system is configured to characterize the volume, density or mass ratio of the gases in the mixture. The system including an outlet valve configured to monitor a flow rate of the process mixture delivered to the process module. The system where the system is configured to control the pressure of a plurality of gas streams such that the partial pressure of the individual gases will equate its desired ratio of the gases in the mixture. Implementations of the described techniques may include hardware, a method or process, or computer software on a computer-accessible medium.

One general aspect includes a gas delivery system for delivering a mixture of gases, the system including: a plurality of solenoid valves configured to receive a plurality of different gases to create a mixture of the different gases in a known reference volume. The gas delivery system also includes the gas delivery system being configured to determine ratio of each of the different gases in the reference volume based on a pressure measured across the plurality of solenoid valves. The gas delivery system also includes the gas delivery system being configured to determine a conversion factor based on the ratio of each of the different gases to derive a calibration curve specifically for the mixture of the different gases in the reference volume. The gas delivery system also includes the gas delivery system being configured use the calibration curve to flow the desired amount of mixture of the different gases into a processing chamber. The gas delivery system also includes determining the compressibility (zₙ) of the mixture of the different gases by summing of the plurality of the known concentrations of each of the gases multiplied by the known compressibility of each of the gases. Other embodiments of this aspect include corresponding computer systems, apparatus, and computer programs recorded on one or more computer storage devices, each configured to perform the actions of the methods.

Implementations may include one or more of the following features. The system where the gas mixture includes gases which are non-reactive with each other. The system where said system is configured to characterize the ratio of the gases in a process mixture before delivery into a process module. The system where the system is configured to characterize the volume, density or mass ratio of the gases in the mixture. The system including an outlet valve configured to monitor a flow rate of the process mixture delivered to the process module. The system where the system is configured to control the pressure of a plurality of gas streams such that the partial pressure of the individual gases will equate its desired ratio of the gases in the mixture. The system where the system is configured to measure rate of decay of the gas mixture. Implementations of the described techniques may include hardware, a method or process, or computer software on a computer-accessible medium.

One general aspect includes a gas delivery system for premixing one or more gases in a flow path to produce a process mixture to be delivered to a process module, including: one or more inlet valves configured to control a pressure of the one or more gases entering the gas delivery system; a reference volume of the gas delivery system being used as a mixing chamber to mix the gases based on the pressures and an individual gas ratio to generate a process mixture; and an outlet valve configured to control a pressure of the process mixture and for delivering the process mixture to the process module through an orifice or flow restrictor. Other embodiments of this aspect include corresponding computer systems, apparatus, and computer programs recorded on one or more computer storage devices, each configured to perform the actions of the methods.

One general aspect includes the gas delivery system as described where a measurement of pressure across the follow restrictor can be single transducer, dual transducer, or a differential pressure transducer. Other embodiments of this aspect include corresponding computer systems, apparatus, and computer programs recorded on one or more computer storage devices, each configured to perform the actions of the methods.

Various embodiments relate to gas and fluid mass flow control methods, systems and apparatuses that are capable of calculating rate of a decay measurements on a gas mixture to determine the flow rate of a process gas mixture. Fluid as used herein is intended to encompass materials which are in a gaseous phase because of specific combinations of pressure and temperature despite whether such materials are gaseous under everyday circumstances. Thus, fluids may include, for example, water vapor or boron trichloride (BCl3), as well as common gaseous materials such as silane (SiH4), argon, helium and nitrogen.

Various embodiments include a gas delivery system for mixing one or more gases in a flow path to produce a gas mixture to be delivered to a processing chamber, including one or more inlet valves configured to control a pressure of the one or more gases entering the gas delivery system; a reference volume of the gas delivery system being used as a mixing chamber to mix the gases based on the pressures and an individual gas ratio to generate a process gas mixture; and one or more outlet valves configured to control a pressure of the process gas mixture and the gas flow system configured to deliver the process mixture to the process module through an orifice or flow restrictor.

In another embodiment, a method for delivering gas by premixing one or more gases in a flow path to produce a process gas mixture to be delivered to a process module, including closing an outlet valve, opening one or more pressure-controlled inlet valves, inletting one or more gases through one or more inlet valves, generating the process mixture by mixing the one or more gases in different ratios, controlling the pressure of gases in the process mixture and opening an outlet valve for delivering the process mixture to the process module.

In an exemplary embodiment, a method of flowing a desired amount of a certain gas mixture comprises: (i) streaming a plurality of different gases into a reference volume to form a gas mixture, (ii) determining the partial pressure of each gas in the reference volume, (iii) determining the conversion factor for the gases based on the partial pressure calculations, (iv) deriving a calibration curve based on the conversion factors and (v) flowing a desired amount of the gas mixture into a reaction chamber based on the calibration curve.

Alternative embodiments relate to other features and combinations of features as may be generally recited in the claims. Embodiments described below allow parallel or serial processing of each method and/or component.

### BRIEF DESCRIPTION OF DRAWINGS

The disclosure will become more fully understood from the following detailed description, taken in conjunction with the accompanying figures, wherein like reference numerals refer to like elements, in which:

FIG. 1A is a prospective view of a mass flow controller, according to an exemplary embodiment.

FIG. 1B is a prospective view of a mass flow controller, according to an exemplary embodiment.

FIG. 2 is a diagram of a flow control system, according to an exemplary embodiment.

FIG. 3 is another schematic diagram of a flow control system in accordance with an exemplary embodiment.

FIG. 4 is a conceptual representation of a mass flow controller in accordance with an exemplary embodiment.

FIG. 5 is a flow diagram for a process in accordance with an exemplary embodiment.

### DETAILED DESCRIPTION

This disclosure is not limited in its application to the details of construction and the arrangement of components set forth in the following description or illustrated in the drawings. The system is capable of other embodiments and of being practiced or of being carried out in various ways. Also, the phrasing and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. The use of directional adjectives “inner, “outer,” “upper,” “lower,” and like terms, are meant to assist with understanding relative relationships among design elements and should not be construed as meaning an absolute direction in space nor regarded as limiting. As used herein the terms “module” or “sub-module” comprise electronic components as well as circuitry, in addition to applications stored on a storage medium and executable on a processor. Examples include, but are not limited to, electronic circuitry, components and applications configured to perform flow decay calculations, communicate with one or more transducers and actuate one or more valves.

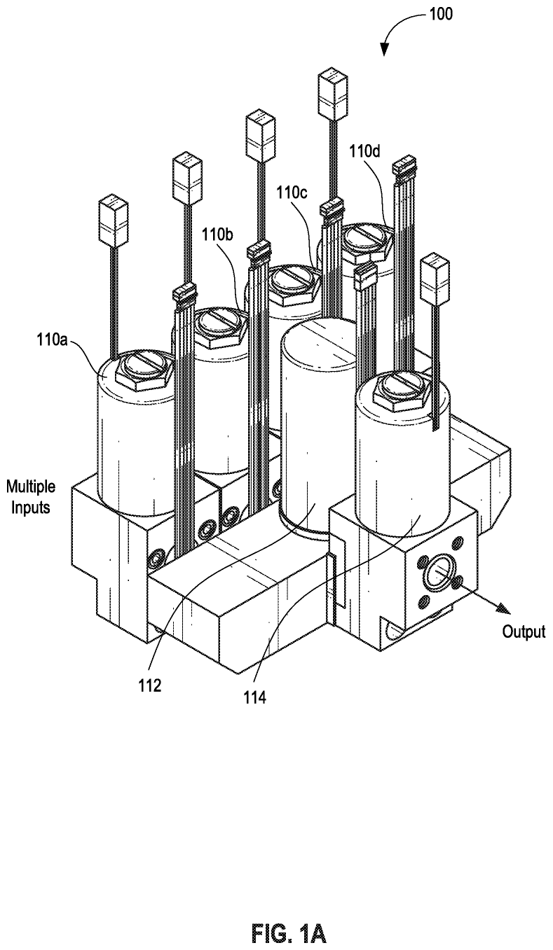

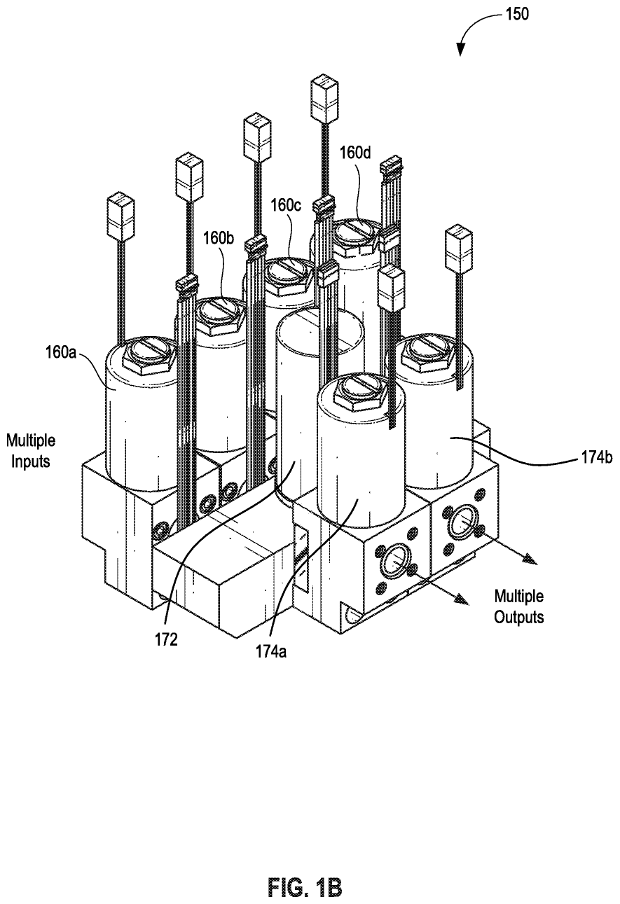

FIG. 1A is a prospective view of a mixing manifold system 100, according to an exemplary embodiment. The mixing manifold system 100 has a plurality of input valves 110a, 110b, 110c and 110d. Although FIG. 1A illustrates a mixing manifold system 100 that has 4 input solenoid valves additional input valves may be included in a mixing manifold system. In various embodiments, the input valves 110a, 110b, 110c and 110d may receive control signals from a controller to vary the pressure of a gas received by the input valves 110a, 110b, 110c and 110d to achieve a desired gas mixture ratio. The input valves 110a, 110b, 110c and 110d may provide the received plurality of gas mixture to a reference volume 112. Next, the reference volume 112 provides the mixed gas to the output valve 114. The output valve 114 output the mixed gas from the reference volume 112 to the processing chamber not shown in FIG. 1A.

FIG. 1B is a prospective view of a mixing manifold system 150, according to an exemplary embodiment. Similar to FIG. 1B, the mixing manifold system 150 has a plurality of input valves 160a, 160b, 160c and 160d. Although FIG. 1B illustrates a mixing manifold system 150 that has 4 input solenoid valves, additional input valves may be included in a mixing manifold system 150. In various embodiments, the input valves 160a, 160b, 160c and 160d may receive control signals from a controller to vary the pressure of a gas received by the input valves 160a, 160b, 160c and 160d to achieve a desired gas mixture ratio. The input valves 160a, 160b, 160c and 160d may provide the received plurality of gas mixture to a reference volume 172. Next, the reference volume 172 provides the mixed gas to the multiple output valves 174a and 174b. The output valves 174a and 174b output the mixed gas from the reference volume 172 to a processing chamber not shown in FIG. 1B. In various embodiments, the mixing manifold system 150 may include more output solenoid valves than shown in FIG. 1B. The gas mixture may be output into various regions of processing chamber.

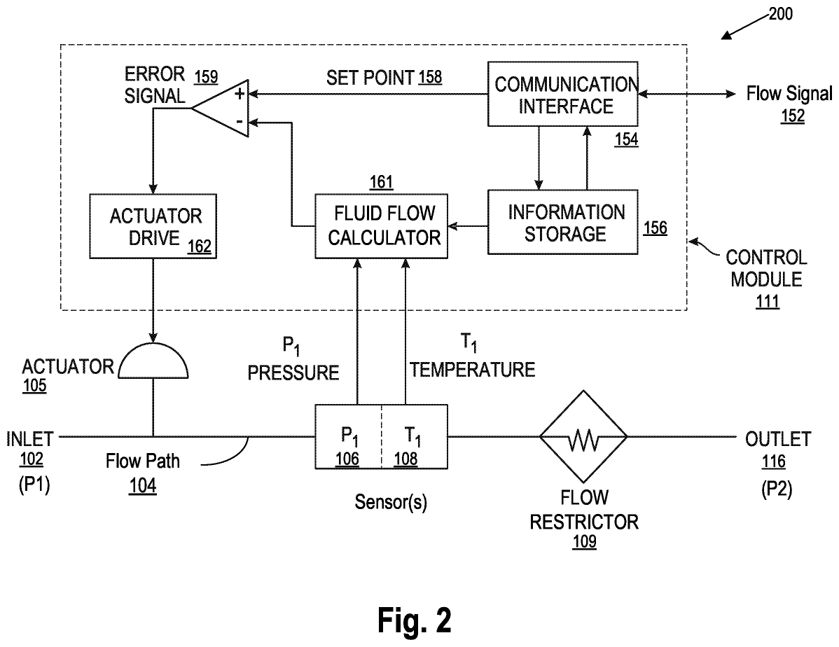

FIG. 2 is a diagram of a flow control system, according to an exemplary embodiment. In an exemplary embodiment, the mass flow controller may include an inlet filter, an inlet regulator (valve), a pressure and temperature sensor, a control volume, an outlet sensor, an outlet regulator and an outlet orifice with filter. Further for specific temperature and pressure measurements the mass flow controller includes a solenoid valve and a transducer. Referring to FIG. 2, an exemplary mass flow controller system 200 is shown where the control module 111 receives signals from the pressure sensor 106 and temperature sensor 108 located downstream from the inlet valve 102 of the fluid conduit (flow path) 104. Accordingly, pressure P1 at the inlet valve 102 and pressure P2 at the outlet valve 116 may be measured and used for calculation at the fluid flow calculator sub-module 161 of the control module 111. In particular, flow rate at the flow restrictor 109 can be measured at various time intervals. Additionally, the control module 111 may store or retrieve information from the information storage sub-module 156, which is in communication with the communication interface sub-module 154. The control module 111 permits determining a set point 158 which may be adjusted based on the error signal 159 component before used by the actuator drive 162 to drive the actuator 105 controlling the inlet valve. As shown, the control module 111 is also configured to receive or output flow signal 152.

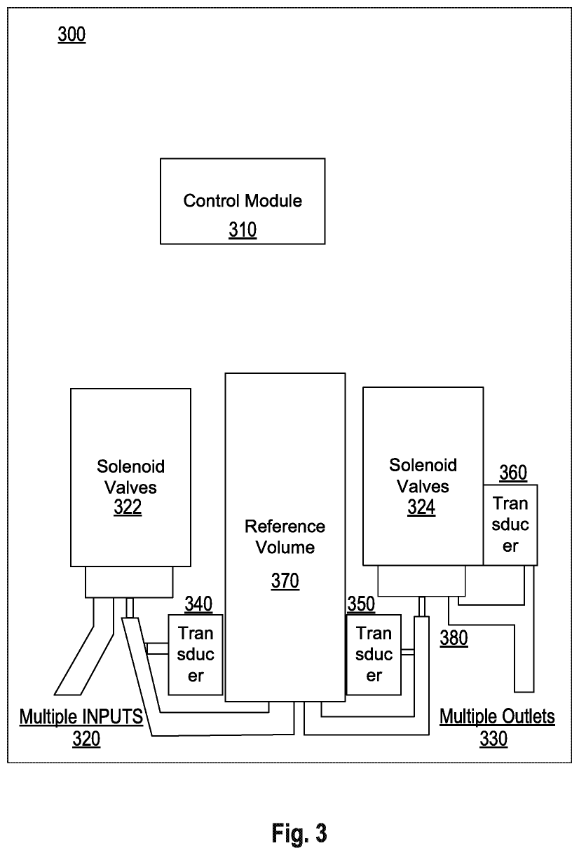

FIG. 3 provides yet another exemplary system. Here, the system 300 comprises a control module 310 and a flow path having an multiple inputs 320 controlled by a plurality of inlet solenoid valves 322 and multiple outlets 330 controlled by multiple outlet solenoid valves 324. Temperature and pressure may be measured at the transducers 340, 350 and 360. As such the rate of decay calculation of gas flow over either reduced flow path 390 or main flow path 380 may be made by the control module. FIG. 3 illustrates a detailed schematic of a gas delivery system, including, one or more inlet valves configured to control a pressure of the one or more gases entering the gas delivery system; a reference volume 370 of the gas delivery system being used as a mixing chamber to mix the gases based on the pressures and an individual gas ratio to generate a process mixture; and an outlet valve configured to control a pressure of the process mixture and for delivering the process mixture to the process module through an orifice or flow restrictor.

In an embodiment of the inventive subject matter, the one or more gases are non-reactive with each other and the inlet valves is an electronic pressure regulator. The gas delivery system, further equipped to characterize the ratio of the gases in the process mixture before delivering the mixed gases to the processing chamber, the inlet valve is chosen from a group comprising of solenoid, piezoelectric or stepper motor valves and the outlet valve is configured to monitor a flow rate of the process gas mixture delivered to the processing chamber. Further the control pressure of each stream is such that the partial pressure of the individual gases will equate its desired ratio in the process mixture.

In an embodiment of the inventive subject matter, if a user chooses to use a mixture of 25% Chlorine, 25% Oxygen and 50% Argon, and wants to deliver a flow from X % to Y % of a known full scale, the system will be operated as follows: Choose an orifice sized to deliver 0.8*Y % of flow at a known inlet pressure (say 30 psia). The system will use real gas law and partial pressure of the system such that gas properties of the mixture will be 0.5*Argon+0.25*Oxygen+0.25*Chlorine. Reducing the inlet pressure to the orifice from 30 psia to 0.6 psia will proportionately control the flow from 100% of full scale to 2% of full scale.

The valves could be solenoid, peizo, stepper motor etc and will be controlling pressure to the orifice and thus controlling flow indirectly. The mixture proportion is achieved by using an electronic regulator for each stream, Cl2, O2 and Ar. The control pressure of each stream will be such that partial pressure of the individual gas will equate its desired ration. For example, Cl2 and O2 will be controlled to 15 psia, and Argon at 30 psia, with outlet valve closed till mixed chamber pressure becomes 30 psia, then inlet valve will be closed and mixed gas delivered for a known pulse.

In an alternate embodiment, the system could operate in a continuous mode where the pressure of O2, Cl2 and Ar is adjusted such that their ratios will deliver 25/25/50% of mixture, and the control pressure of the orifice could be then be adjusted to a lower number to achieve differential pressure across the flow path and maintain accurate mixed flow. One example being 15 psia, 15 psia, 30 psia, and outlet pressure is 7 psia to deliver a certain flow. The gas delivery system, further equipped to operate in an on demand real time mixing mode and a measurement capability for pressure across the flow restrictor using a single transducer, dual transducer, or a differential pressure transducer.

In another embodiment, a method for delivering gas by premixing one or more gases in a flow path to produce a process mixture to be delivered to a process module, includes closing an outlet valve, opening one or more pressure-controlled inlet valves, inletting one or more gases through one or more inlet valves, generating the process mixture by mixing the one or more gases in different ratios, controlling the pressure of gases in the process mixture and opening an outlet valve for delivering the process mixture to the process module.

Multiple gases are pre-mixed in the reference volume from a plurality of inlet valves instead of being mixed in a mixing manifold after using multiple MFCs. The pre-mixed gas ratio can be characterized, and system can be calibrated to ensure plasma is sent appropriately and fast, reducing processing times and delivering accurate process mixture as required.

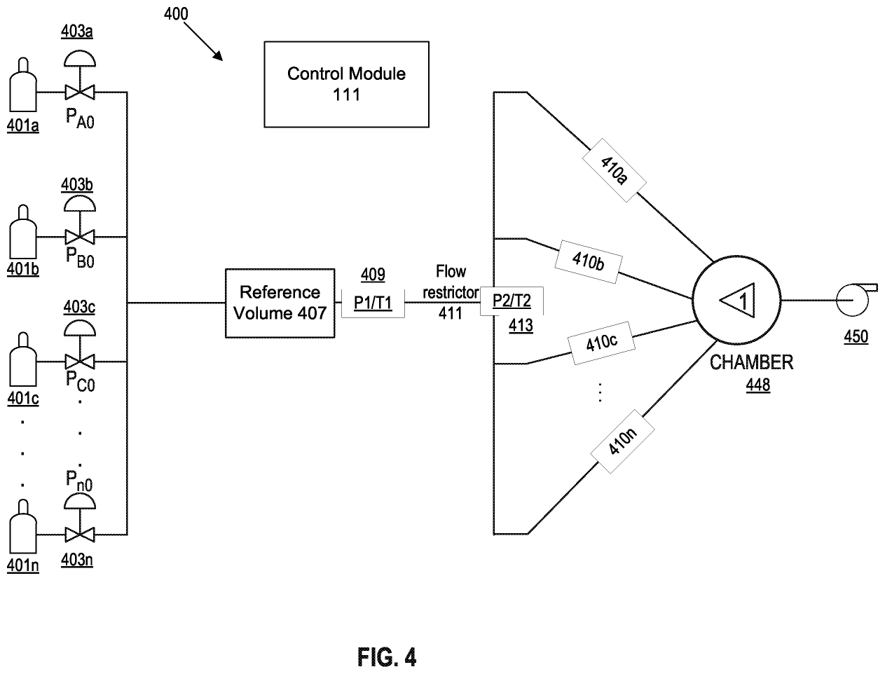

FIG. 4 illustrates a schematic diagram of a system 400 according to an embodiment. System 400 includes multiple input gases 401a, 401b, 401c . . . and up to 401n that are in fluidic communication with multiple input valves 403a, 403b, 403c . . . and up to 403n. The input valves 403a, 403b, 403c . . . and up to 403n may have an electronic pressure regulator or solenoids that can regulate the pressure across the input valve. In some embodiments, the input valves may reduce the pressure from the input gases such that the ratio of the gas from one valve is different from the ratio of the gas from another valve.

A plurality of solenoid outlet valves 410a, 410b, 410c . . . up to 410n may control the pressure of the mixed gases that are dispersed into various portions of the chamber 448. Vacuum 450 may create a vacuum that sucks in the mixed gasses into the chamber 448.

By way of example, a batch process may request a mixture of gases according to the follow ratios. A batch process may require that a mixture of gas that has 30% cl2, 20% O₂, 20% Ar or CF₄, and 30% He be provided to the processing chamber. The embodiments of the various system may be able to provide this mixture using as little as a single MFC system as disclosed herein. For this example, only 4 of the input valves may be utilized. Input valve 303a may receive cl₂ and the input valve may be configured to regulate the pressure of the cl₂ to 30 psi. Input valve 403b may receive O₂ and the input valve 403b may be configured to regulate the pressure of the O₂ to 20 psi. Input valve 403c may receive Ar and the input valve 403c may be configured to regulate the pressure of the Ar to 30 psi. Input valve 403d (no shown) may receive He and the input valve 403n may be configured to regulate the pressure of the He to 30 psi. Next the gases may be combined into a mixture in a reference volume 307 via a gas line that mixes and sends the gases to the reference volume 407. According to Dalton's law stated below for reference, the partial pressure of the gases will verify that the ratio of the mixed gases is at 30% cl₂, 20% O₂, 20% Ar or CF₄, and 30% He due to the pressure as regulated by Dalton's law at state below.

Accordingly, the system 400 is configured to determine the total moles (n) for each gas that have been delivered to the reference volume and at a later time may determine the total number of moles delivered to the processing chamber. In various embodiments, the partial pressure may be used to derive a conversion factor. In the above equation, z₁, z₂, z₃ and zₙ may be the gas property or compressibility factor for each of the gases that are being fed into the processing chamber. The system is capable of using the knowledge of partial pressure of the various gases in the gas mixture to allow the system to use the pressure and temperature to derive the necessary properties such as relative density of the mixture of gases while maintaining constant gas flow.

A conversion factor is derived using the relative density of the individual gases and the knowledge of the concentration of the individual gases in the gas mixture. The knowledge of the concentration of the individual gases in the gas mixture could be determined by knowing the actual concentration or could be determined based on knowing the partial pressure. Then, the conversion factor may be used to determine a new calibration curve for the mixed gas dynamically in order to control the flow rate. The conversion factor is used because the mixing manifold may have been calibrated using Nitrogen and properties of the mixed gas would different and thus a conversion factor may be applied to Nitrogen calibration curve.

Accordingly, the mixing manifold system is capable of determining the conversion factor-based calibration curve and control the flow rate for any mixture of the gases in real-time based on a desired mixture. A system may be calibrated on Nitrogen and have calibration curve for the flow restrictor 411. Accordingly, the calibration curve must be changed by using the conversion factor.

In other embodiments, the volume ratio between the pressure of the reference volumes and the pressure and the volume of the processing chamber may be used to determine the total partial moles of the mixed gas that is delivered to the processing chamber.

A system with a plurality of inlet valves that have a pressure sensor that may be used to measure the pressure across the inlet valve. The plurality of inlet valves that are solonoid valves having a plurality of pressure regulators. The inlet valves may be controlled such that each of the different gasses that are received by the plurality of inlet valves allow a specified ratio of gases to enter the reference volume. The plurality of inlet valves feed gas via a manifold directly into a reference volume which has a volume that is known or provided by the manufacturer of the mixing manifold. As the gas mixture is fed into the reference volume the pressure of the gas equilibrates in the reference volume to be less than the pressure of the lowest pressure of the plurality of gases. For example, gases 401a, 401b, 401c, . . . and 401n may be fed into the input valves 403a, 403b, 403c . . . and 403n. Valve 403a may control the pressure of gas 401a (P_{gasA}) to be 60 psi. Valve 403b may control the pressure of gas 401b (P_{gasB}) to be 40 psi. Valve 403c may control the pressure of gas 401c (P_{g}asc) to be 40 psi. Valve 403n may control the pressure of gas 401n (P_{gasD}) to be 60 psi. According the ratio or concentration of the mixture of gases 401a, 401b, 401c, . . . and 401n in the reference volume may be 3:2:2:3. The pressure in the reference volume 407 (P_{refV}) may be less than the lowest pressure from the pressures of the various gases (P_{gasA}, P_{gasB}, P_{gasC}, and P_{gasD}). In order to flow gas into the chamber 448, the pressure (P1) and temperature (T1) 409 may be held to be lower than the pressure within the reference volume 407. The flow restrictor 411 may be an orifice or the like with a calibration curve. Pressure drop or change across Pressure 2/Temperature 2 may be measured by a pressure/temperature sensor 413.

In other embodiments, the ideal gas law PV=zₙnrt may be used to determine the total number of moles delivered. The compressibility factor for the gas mixture Zₙ to may be determined by utilizing the concentration or partial pressure of each gas multiplied by the compressibility of each constituent gas.

Zₙ=C₁*z₁+C₂*z₂+C₃* z₃ . . . +Cₙ*zₙ Equation 1:

Upon determining Zₙ the ideal gas equation may be used to determine the total number of moles (n) delivered to the chamber. The total moles calculations may allow the system to confirm that a transducer has not shifted, or the gas line have not corroded. Accordingly, the above method allows for real time diagnostics and run a rate of delay calculation to verify the flow rate. A control module 111 configured to control the valves 403, 403b, 403c . . . and 403n, there pressure and temperature sensor 409, flow restrictor 411, pressure and temperature sensor 413, and solenoid outlet valves 410a, 410b, 410c . . . up to 410n to deliver the desired amount of gas.

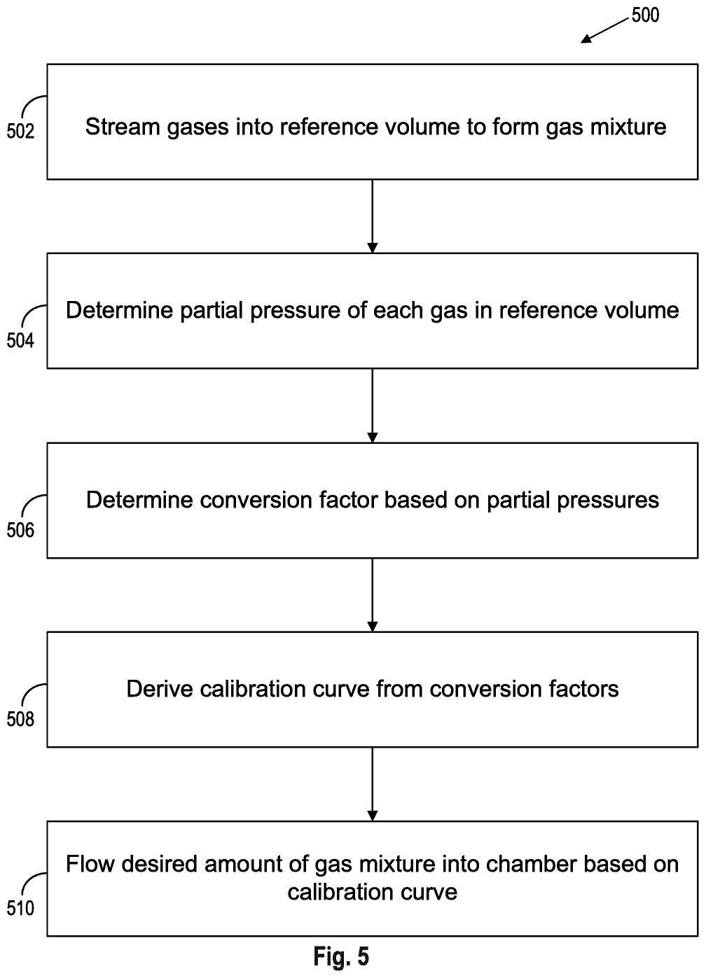

The method of dynamically determining the calibration curve for a gas mixture in accordance with an exemplary embodiment is provided in FIG. 5. The method 500 for flowing a desired amount gas mixture involves streaming different gases into a reference volume as shown in step 502. Partial pressure of each gas in the mixtures is then determined in step 504. Next the conversion factor(s) is calculated based on the partial pressures, as shown in step 506. In the subsequent step 508, a calibration curve is derived based on the conversion factor(s). Finally, a desired amount of gas mixture is flown from the reference volume into the gas chamber based on the calibration curve, as shown in step 510.

Having thus described several aspects of at least various embodiments of this system, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. A gas delivery system for delivering a mixture of gases, the system comprising:
a plurality of solenoid valves configured to deliver a plurality of different gases to create a mixture of the different gases in a known reference volume;
the gas delivery system being configured to determine a partial pressure of each of the different gases in the reference volume;
the gas delivery system being configured to determine a conversion factor based on the partial pressure of each of the different gases to derive a calibration curve specifically for the mixture of the different gases in the reference volume; and
the gas delivery system being configured use the calibration curve to flow a desired amount of mixture of the different gases into a chamber.

2. The system of claim 1, wherein the gas mixture comprises gases which are non-reactive with each other.

3. The system of claim 1, wherein the system is configured to characterize a ratio of one or more gases in a process mixture before delivery into a process module.

4. The system of claim 3, wherein the system is configured to characterize a volume, density or mass ratio of the gases in the mixture.

5. The system of claim 3, comprising an outlet valve configured to monitor a flow rate of the process mixture delivered to the process module.

6. The system of claim 1, wherein the system is configured to control a pressure of a plurality of gas streams such that the partial pressure of one or more individual gases will equate its desired ratio of the gases in the mixture.

7. A gas delivery system for delivering a mixture of gases, the system comprising:
a plurality of solenoid valves configured to deliver a plurality of different gases to create a mixture of the different gases in a known reference volume;
the gas delivery system being configured to determine a ratio of each of the different gases in the reference volume based on a pressure measured across the plurality of solenoid valves;
the gas delivery system being configured to determine a conversion factor based on the ratio of each of the different gases to derive a calibration curve specifically for the mixture of the different gases in the reference volume; and
the gas delivery system being configured to use the calibration curve to flow a desired amount of mixture of the different gases into a processing chamber.

8. The system of claim 7, wherein the gas mixture comprises gases which are non-reactive with each other.

9. The system of claim 7, wherein said system is configured to characterize the ratio of the gases in a process mixture before delivery into a process module.

10. The system of claim 9, wherein the system is configured to characterize the volume, density or mass ratio of the gases in the mixture.

11. The system of claim 9, comprising an outlet valve configured to monitor a flow rate of the process mixture delivered to the process module.

12. The system of claim 7, wherein the system is configured to control the pressure of a plurality of gas streams such that a partial pressure of one or more individual gases will equate its desired ratio of the gases in the mixture.

13. A gas delivery system for delivering a mixture of gases, the system comprising:
a plurality of solenoid valves configured to receive a plurality of different gases to create a mixture of the different gases in a known reference volume;
the gas delivery system being configured to determine ratio of each of the different gases in the reference volume based on a pressure measured across the plurality of solenoid valves;
the gas delivery system being configured to determine a conversion factor based on the ratio of each of the different gases to derive a calibration curve specifically for the mixture of the different gases in the reference volume; and
the gas delivery system being configured use the calibration curve to flow a desired amount of mixture of the different gases into a processing chamber; and
determining a compressibility (Zn) of the mixture of the different gases by summing of the plurality of a known concentrations of each of the gases multiplied by a known compressibility of each of the gases.

14. The system of claim 13, wherein the gas mixture comprises gases which are non-reactive with each other.

15. The system of claim 13, wherein said system is configured to characterize the ratio of the gases in a process mixture before delivery into a process module.

16. The system of claim 15, wherein the system is configured to characterize the volume, density or mass ratio of the gases in the mixture.

17. The system of claim 15, comprising an outlet valve configured to monitor a flow rate of the process mixture delivered to the process module.

18. The system of claim 13, wherein the system is configured to control the pressure of a plurality of gas streams such that the partial pressure of one or more individual gases will equate its desired ratio of the gases in the mixture.

19. The system of claim 13 wherein the system is configured to measure rate of decay of the gas mixture.
